(19) United States
(12) Patent Application Publication
(10) Pub. No.: US 2024/0103401 A1
(43) Pub. Date: Mar. 28, 2024

(54) DEVELOPING DEVICE AND IMAGE FORMING APPARATUS

(71) Applicant: FUJIFILM Business Innovation Corp., Tokyo (JP)

(72) Inventor: Takashi ANZAI, Kanagawa (JP)

(73) Assignee: FUJIFILM Business Innovation Corp., Tokyo (JP)

(21) Appl. No.: 18/181,219

(22) Filed: Mar. 9, 2023

(30) Foreign Application Priority Data
Sep. 27, 2022 (JP) 2022-153542

(51) Int. Cl. G03G 15/08

(52) U.S. Cl. CPC G03G 15/0886; G03G 15/0875; G03G 2215/0692

(57) ABSTRACT

A developing device includes: a storage portion that stores a developer and has an exit for the developer and a hole portion, the hole portion including a limiting portion; a sealing member with which the exit of the storage portion is sealed; a loosening member that is disposed in the storage portion so as to be pulled out through the hole portion of the storage portion and loosens the developer by being pulled out of the storage portion; and a closing member that is disposed in the hole portion of the storage portion, cleans the loosening member that is pulled out of the hole portion by being in contact with the loosening member, and closes the hole portion of which the loosening member has been pulled out, the closing member including a caught portion. The limiting portion of the hole portion of the storage portion limits a movement of the closing member in a pull-out direction of the loosening member by catching the caught portion.

### CROSS-REFERENCE TO RELATED APPLICATIONS

This application is based on and claims priority under 35 USC 119 from Japanese Patent Application No. 2022-153542 filed Sep. 27, 2022.

### BACKGROUND

### (i) Technical Field

The present disclosure relates to a developing device and an image forming apparatus.

### (ii) Related Art

Japanese Unexamined Patent Application Publication No. 2011-107644 discloses a developing device including: a developer holding member extending in a medium width direction intersecting a transport direction of a medium on which an image is recorded, and facing an image holding body having a surface on which a latent image is formed, the developer holding member rotating while holding a developer on a surface thereof; a developing housing that has a holding-member mount unit in which the developer holding member is mounted and that accommodates a developer in the developing housing; a developer storage portion that is connected to the developing housing through an inflow port and stores a developer that is to flow into the developing housing; a partition member disposed in the developer storage portion and partitioning the inner space of the developer storage portion; and a loosening member including a loosening portion that is disposed inside the developer storage portion and extends along a one-side surface and the other-side surface of the partition member partitioning the developer storage portion, and a drawable portion that is connected to the loosening portion and extends from a loosening and drawing port formed in the developer storage portion to the outside of the developer storage portion. When the drawable portion is drawn out, the loosening portion moves in a direction intersecting the one-side surface and the other-side surface of the partitioning member and loosens the developer in the developer storage portion.

Japanese Examined Patent Publication No. 6-058569 discloses a developer container that has a container body having a bottom part having an opening and contains a developer. The developer container includes: a flexible seal member that is removably bonded to, in the bottom part of the container body, a surface of a peripheral edge part along the opening and with which the opening and the vicinity thereof is able to be sealed and opened; and a sliding cover that slides in a direction orthogonal to a removal direction of the seal member and closes the bottom part of the container body. The sliding cover includes a stop member. The stop member prevents the flexible seal member from opening the opening and the vicinity thereof when the sliding cover maintains the bottom part of the container body in a closed state, and the stop member causes the flexible seal member to open the opening and the vicinity thereof by the sliding cover sliding in the direction orthogonal to the removal direction of the flexible seal member.

### SUMMARY

Aspects of non-limiting embodiments of the present disclosure relate to a developing device that, compared with a configuration where in a pull-out hole portion through which a loosening member is pulled out from an inner space of a storage portion that stores a developer, a closing member is disposed in the pull-out direction so as to move, is able to suppress the closing member from coming out of the pull-out hole portion when the loosening member is pulled out.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a developing device including: a storage portion that stores a developer and has an exit for the developer and a hole portion, the hole portion including a limiting portion; a sealing member with which the exit of the storage portion is sealed; a loosening member that is disposed in the storage portion so as to be pulled out through the hole portion of the storage portion and loosens the developer by being pulled out of the storage portion; and a closing member that is disposed in the hole portion of the storage portion, cleans the loosening member that is pulled out of the hole portion by being in contact with the loosening member, and closes the hole portion of which the loosening member has been pulled out, the closing member including a caught portion, wherein the limiting portion of the hole portion of the storage portion limits a movement of the closing member in a pull-out direction of the loosening member by catching the caught portion.

### BRIEF DESCRIPTION OF THE DRAWINGS

An exemplary embodiment of the present disclosure will be described in detail based on the following figures, wherein:

FIG. 1 is a schematic view of an image forming apparatus according to the present exemplary embodiment;

FIG. 2 is a schematic view of a developing device according to the present exemplary embodiment;

FIG. 3 is a schematic view of the developing device in FIG. 2 whose accommodation portion has been supplied with a developer stored in a storage housing by a Mylar portion (Mylar is a registered trademark) loosening the developer;

FIG. 4 is a schematic view of the storage housing of which the Mylar portion has been pulled out;

FIG. 5 is a sectional side view of the storage housing in FIG. 2 when the storage housing is cut in the front-back direction;

FIG. 6 is an enlarged view of a part indicated by arrow VI in FIG. 5;

FIG. 7 is a front view of a part of the storage housing in FIG. 6 when the part is viewed in a direction of arrow VII;

FIG. 8 is a sectional side view of the storage housing in FIG. 5 of which a sealing member has been pulled out and the Mylar portion is then being pulled out;

FIG. 9 is an enlarged view of a part indicated by arrow IX in FIG. 8;

FIG. 10 is a sectional side view of the storage housing in FIG. 8 of which the Mylar portion has been pulled out;

FIG. 11 is an enlarged view of a part indicated by arrow XI in FIG. 10;

FIG. 12 is a side view of a sealing clip;

FIG. 13 is a front view of the sealing clip in FIG. 12 when the sealing cap is viewed in a direction of arrow XIII;

FIG. 14 is a front view of the sealing clip in FIG. 12 when the sealing cap is viewed in a direction of arrow XIV; and

FIG. 15 is a sectional view of a modification of the developing device according to the present exemplary embodiment and corresponds to FIG. 6.

### DETAILED DESCRIPTION

Hereinafter, an example of an exemplary embodiment according to the present disclosure will be described based on the drawings.

Image Forming Apparatus 10

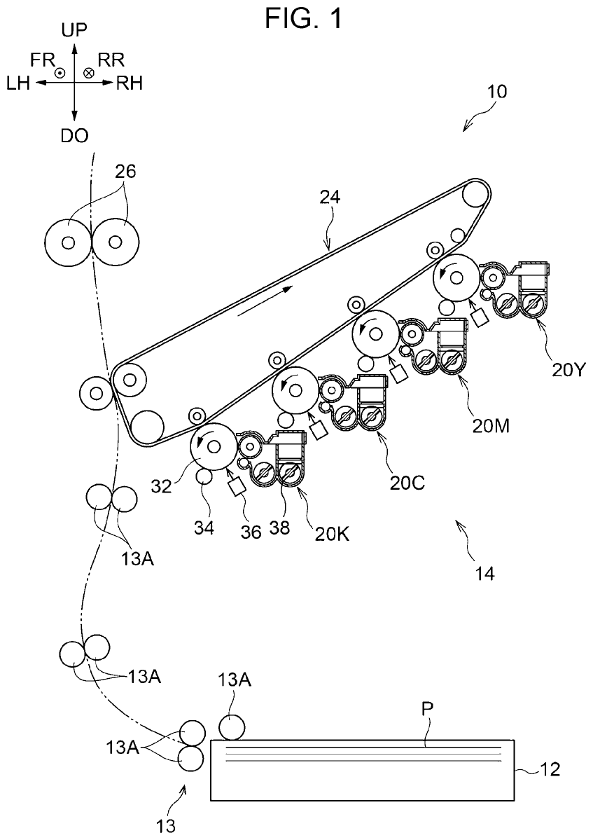

The configuration of an image forming apparatus 10 according to the present exemplary embodiment will be described. FIG. 1 is a schematic view of the configuration of the image forming apparatus 10 according to the present exemplary embodiment.

Note that, in the drawings, arrow UP indicates the upper side of the apparatus (specifically, the upper side in the vertical direction), and arrow DO indicates the lower side of the apparatus (specifically, the lower side in the vertical direction). In the drawings, arrow LH indicates the left side of the apparatus, and arrow RH indicates the right side of the apparatus. In the drawings, arrow FR indicates the front side of the apparatus, and arrow RR indicates the back side of the apparatus. The above-described directions are defined for convenience of description and do not limit the configuration of the apparatus. Note that, when the apparatus is described with the above-described directions, the term “apparatus” is sometimes omitted. For example, the “upper side of the apparatus” is sometimes simply given as the “upper side”.

In addition, in the following description, the “up-down direction” is used as “both directions to the upper side and the lower side” or “one of the directions to the upper side and the lower side”. The “left-right direction” is used as “both directions to the right side and the left side” or “one of the directions to the right side and the left side”. Note that the “left-right direction” may alternatively be expressed by using beside, the lateral direction, and the horizontal direction. The “front-back direction” is used as “both directions to the front side and the back side” or “one of the directions to the front side and the back side”. Note that the “front-back direction” may alternatively be expressed by using beside, the lateral direction, and the horizontal direction. Moreover, the up-down direction, the left-right direction, and the front-back direction intersect one another (specifically, the directions are orthogonal to one another).

In the drawings, a symbol of an encircled cross represents an arrow directed from the near side to the far side of the paper on which each of the figures is illustrated. In the drawings, a symbol of an encircled solid filled circle represents an arrow directed from the far side to the near side of the paper.

The image forming apparatus 10 in FIG. 1 forms an image. As FIG. 1 illustrates, the image forming apparatus 10 specifically includes a medium storage portion 12, a transport unit 13, and an image forming section 14. Hereinafter, each of the parts of the image forming apparatus 10 will be described.

Medium Storage Portion 12 and Transport Unit 13

In the image forming apparatus 10, the medium storage portion 12 accommodates a recording medium P. The recording medium P stored in the medium storage portion 12 is fed to the image forming section 14. The recording medium P to be stored in the medium storage portion 12 is a subject on which an image is formed by the image forming section 14. Examples of the recording medium P include paper and films. Examples of such films include a resin film and a metal film. Note that the recording medium P is not limited to the above-described materials, and various types of recording mediums may be used.

The transport unit 13 in FIG. 1 transports the recording medium P stored in the medium storage portion 12 to a discharge portion, which is not illustrated. As FIG. 1 illustrates, the transport unit 13 specifically includes transport members 13A including plural transport rollers and other members and transports the recording medium P with the transport members 13A. Note that, examples of the transport members 13A may include a transport belt and a transport drum, and various transport members may be used.

Image Forming Section 14

The image forming section 14 in FIG. 1 forms an image on the recording medium P transported by the transport unit 13 (specifically by the transport members 13A). Specifically, the image forming section 14 forms a toner image, which is an example of an image, on a recording medium P by an electrophotographic system. More specifically, as FIG. 1 illustrates, the image forming section 14 includes toner image forming units 20Y, 20M, 20C, and 20K (hereinafter, referred to as 20Y to 20K), a transfer body 24, and a fixing portion 26.

Each of the toner image forming units 20Y to 20K includes a photoconductor 32. Note that the toner image forming units 20Y to 20K are configured in a similar manner, and a reference sign of each of the constituents of the toner image forming units 20Y, 20M, and 20C is thus omitted from FIG. 1.

The photoconductor 32 is an example of a holding body and is a structure for holding a latent image. Specifically, the photoconductor 32 rotates in one direction such as the counterclockwise direction in FIG. 1. In the vicinity of the photoconductor 32, a charging device 34, an exposure device 36, and a developing device 38 are arranged in this order from the upstream side in the rotation direction of the photoconductor 32.

In each of the toner image forming units 20Y to 20K, the charging device 34 charges the photoconductor 32 (charging step). Further, the exposure device 36 exposes the photoconductor 32 that has been charged by the charging device 34 and forms a latent image (specifically, an electrostatic latent image) on the photoconductor 32 (exposure step). The photoconductor 32 holds the latent image that has been formed by the exposure device 36.

The developing device 38 then develops the latent image held on the photoconductor 32 (development step). Accordingly, a toner image is formed on the photoconductor 32. Note that a specific configuration of the developing device 38 will be described later.

In the image forming section 14, the toner image forming units 20Y to 20K perform the charging, exposure, and development steps and form toner images of the respective colors: yellow (Y), magenta (M), cyan (C), and black (K) on the transfer body 24. Moreover, the image forming section 14 transfers the toner images of the respective colors formed on the transfer body 24, onto a recording medium P and fixes the toner images to the recording medium P at the fixing portion 26. In this way, the image forming section 14 employs an intermediate transfer system in which an image is transferred onto a recording medium P with the transfer body 24.

Note that the system used for the image forming section is not limited to such the intermediate transfer system. A direct transfer system in which an image is directly transferred onto a recording medium P may alternatively be used for the image forming section, and various types of image forming sections may be adopted.

Developing Device 38

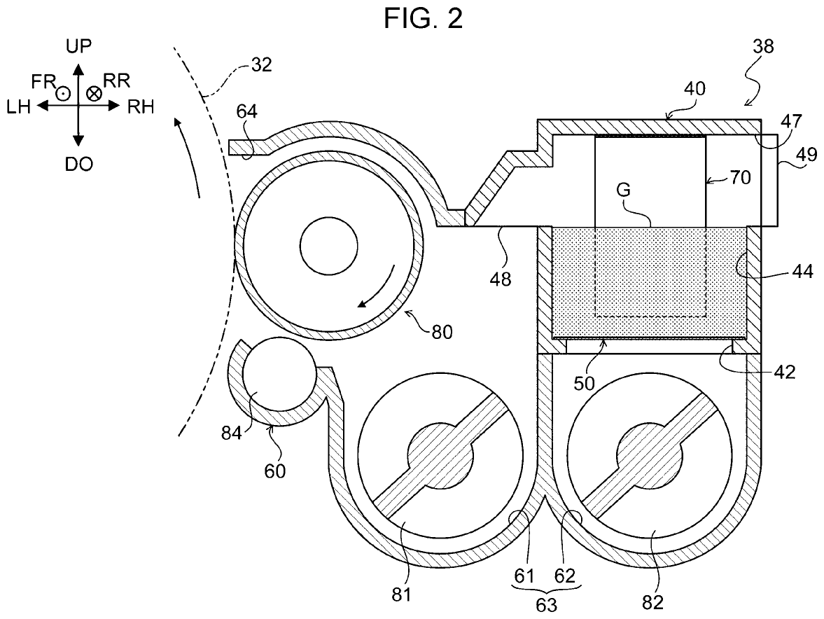

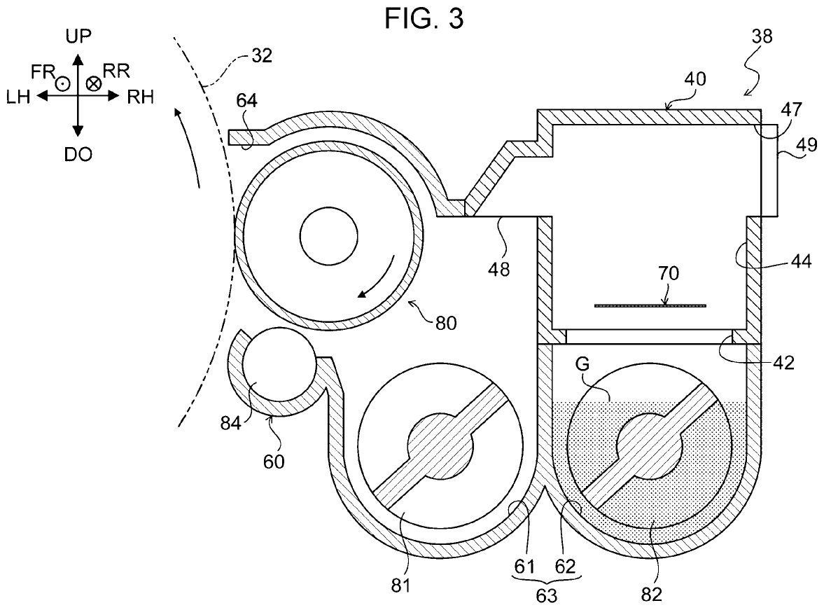

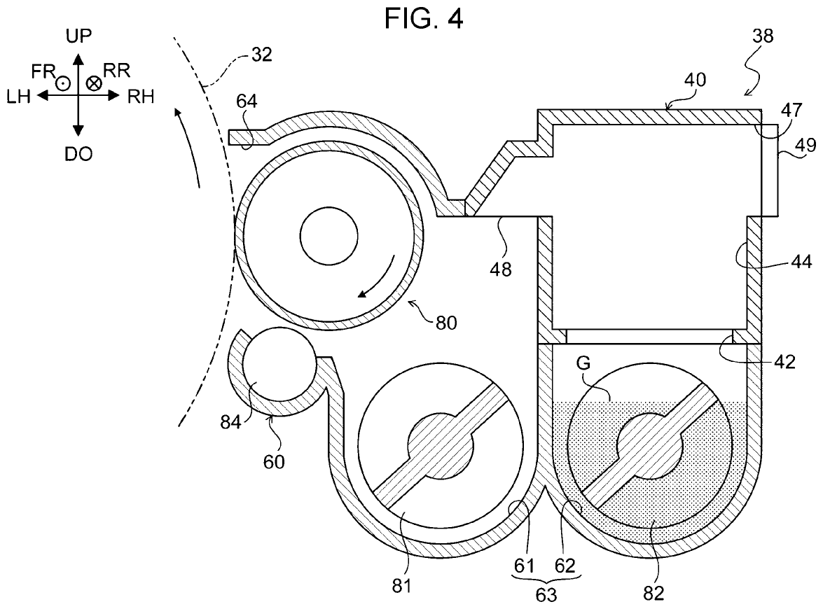

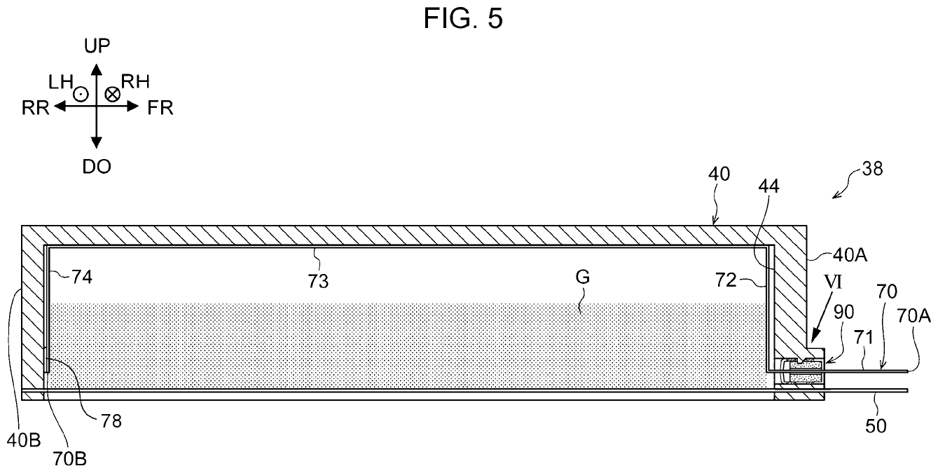

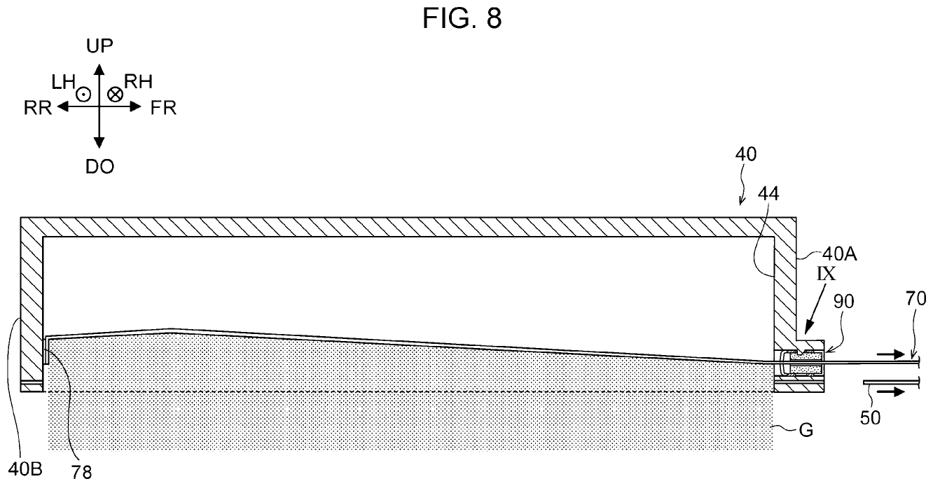

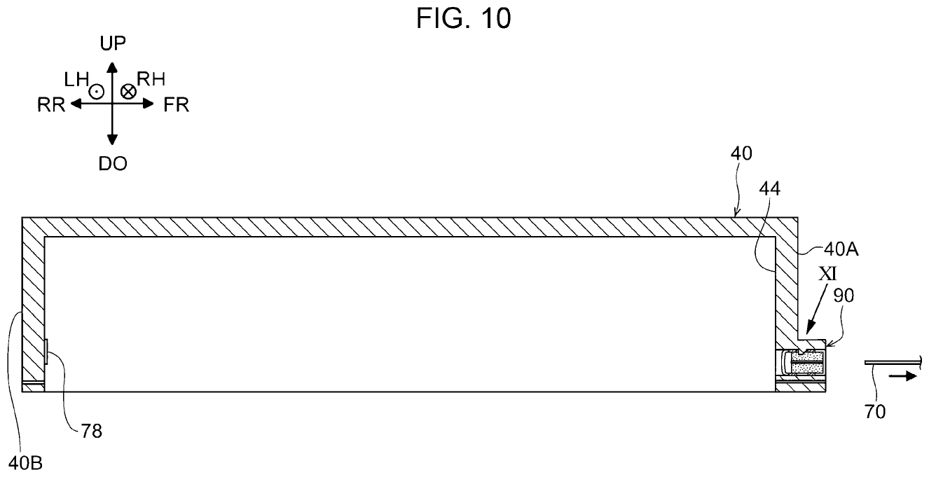

FIG. 2, FIG. 3, and FIG. 4 are schematic views of the developing device 38. FIG. 5, FIG. 8, and FIG. 10 are sectional side views of a storage housing 40 included in the developing device 38.

The developing device 38 illustrated in FIG. 2, FIG. 3, and FIG. 4 develops, with a developer G, a latent image held on the photoconductor 32 as described above. Note that the developer G contains toner and a magnetic carrier. As FIG. 2 and other figures illustrate, the developing device 38 specifically includes the storage housing 40, a sealing member 50, a device housing 60, a Mylar portion 70, a sealing clip 90, a caught portion 100, and a limiting portion 110. Hereinafter, each of the parts of the developing device 38 will be described.

Storage Housing 40

The storage housing 40 illustrated in FIG. 2, FIG. 3, and FIG. 4 is an example of a storage portion of the present disclosure. The storage housing 40 has a box shape formed long in the front-back direction. As FIG. 2 illustrates, the storage housing 40 has an opening portion 42 opened downward and accommodates (stores) the developer G thereinside (in an inner space 44). Note that the opening portion 42 serves as an exit for the developer G in the storage housing 40.

As FIG. 2 illustrates, the storage housing 40 has an inflow port 48. The inflow port 48 is a port portion through which the developer G (specifically, toner) that has been raised up from an accommodation portion 63 (specifically, from a supply path 61), which will be described later, flows into the inner space 44 from which the developer G has fallen. The inflow port 48 differs from the opening portion 42. In the present exemplary embodiment, the inflow port 48 is opened at a position above the supply path 61. Specifically, the inflow port 48 is opened downward at a position on the upper side relative to the supply path 61.

As FIG. 2 illustrates, the storage housing 40 further has a charging port 47 for a developer G. A developer G is charged into the inner space 44 through the charging port 47. The charging port 47 is closed by a cap 49 after the developer G has been charged into the storage housing 40.

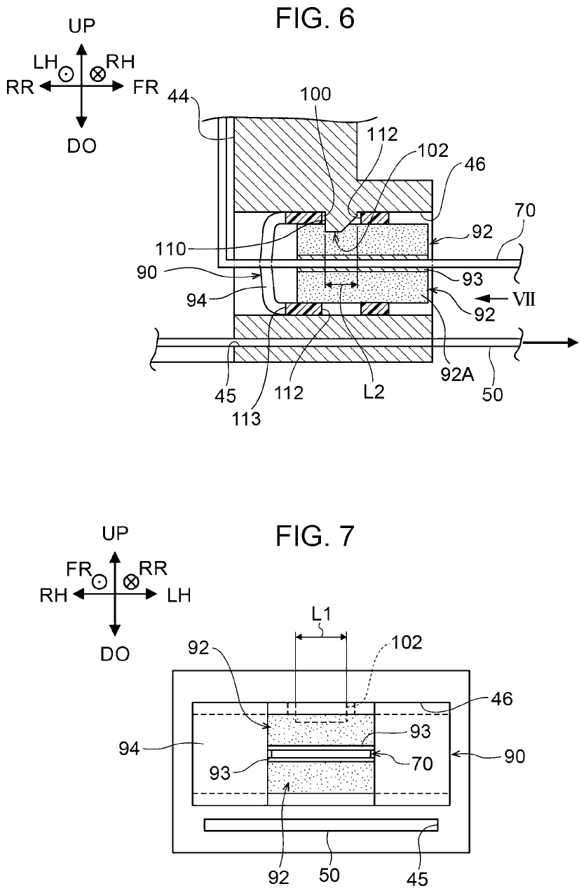

As FIG. 6 illustrates, a front wall of the storage housing 40 has a pull-out hole 45 for the sealing member 50, which will be described later, and a pull-out hole portion 46 for the Mylar portion 70, which will be described later.

Sealing Member 50

With the sealing member 50 illustrated in FIG. 2 and FIG. 5, the opening portion 42 is sealed. The sealing member 50, by being removed, causes the developer G to fall through the opening portion 42. That is, when the opening portion 42 sealed with the sealing member 50 is opened, the developer G stored in the storage housing 40 falls through the opening portion 42 by the own weight thereof.

The sealing member 50 has a film shape. Examples of the material of the sealing member 50 include a resin film. At the opening portion 42, the sealing member 50 is bonded to the storage housing 40, for example, by fusion bonding, that is, so-called heat sealing. Here, a portion of the sealing member 50 sticks out of the storage housing 40 through the pull-out hole 45, and a user catches hold of the sticking-out portion and pulls out the sealing member 50 frontward to open the opening portion 42 (refer to FIG. 3 and FIG. 8).

Note that the sealing member 50 may be made of a metal film. In addition, the sealing member 50 may be bonded to the storage housing 40 by using, for example, a bonding method with a substance such as an adhesive.

Device Housing 60

The device housing 60 illustrated in FIG. 2, FIG. 3, and FIG. 4 accommodates therein the developer G that has fallen from the storage housing 40 through the opening portion 42 of the storage housing 40.

With the developing devices 38 being mounted in the respective toner image forming units 20Y to 20K, in each of the toner image forming units 20Y to 20K, the device housing 60 has an opening portion 64 opened toward the photoconductor 32 (specifically, toward the left) as FIG. 2, FIG. 3, and FIG. 4 illustrate. A developing roller 80 that supplies the photoconductor 32 with a developer G is provided in the device housing 60 so that a portion of the developing roller 80 is exposed from the opening portion 64. A layer regulating member 84 is provided below the developing roller 80. Note that FIG. 2, FIG. 3, and FIG. 4 illustrate the photoconductor 32 with the developing device 38 being mounted in a corresponding one of the toner image forming units 20Y to 20K.

The developing roller 80 holds a developer G on the outer circumferential surface thereof and transports the developer G to a facing position where the developing roller 80 faces the photoconductor 32. The layer regulating member 84 regulates the thickness of a layer of the developer G (developer amount) that is transported toward the facing position. The developer G (specifically, toner) on the developing roller 80 is then supplied to the photoconductor 32 at the facing position, and an electrostatic latent image formed on the photoconductor 32 is developed with the developer G (specifically, toner).

The device housing 60 further includes the accommodation portion 63 that accommodates the developer G that has fallen through the opening portion 42 of the storage housing 40. The accommodation portion 63 includes the supply path 61 serving as a first transport path, and a stirring path 62 serving as a second transport path.

The supply path 61 is disposed on the lower side and the right side relative to the developing roller 80 and extends in the front-back direction. Specifically, the supply path 61 is positioned diagonally to the lower right of the developing roller 80 and extends in the front-back direction. In the supply path 61, the developer G that is to be supplied to the developing roller 80 is accommodated and transported in a transport direction (specifically, to one side in the front-back direction). Specifically, a transport auger 81 serving as a transport member is disposed in the supply path 61, and, in the supply path 61, the developer G is transported in the transport direction (specifically, to the one side in the front-back direction) by the rotation of the transport auger 81.

The stirring path 62 is disposed so as to extend adjacently along the supply path 61. Specifically, the stirring path 62 is disposed on the right side relative to the supply path 61 and extends in the front-back direction. A front end portion and a back end portion of the stirring path 62 are connected to a front end portion and a back end portion of the supply path 61, respectively, and the stirring path 62 and the supply path 61 thus form a circulating path.

In the stirring path 62, the developer G that is to be supplied to the supply path 61 is accommodated and transported in a direction opposite to the transport direction (specifically, to the other side in the front-back direction). Specifically, a transport auger 82 serving as the transport member is disposed in the stirring path 62, and, in the stirring path 62, the developer G is transported, while being stirred, in the direction opposite to the transport direction (specifically, to the other side in the front-back direction) by the rotation of the transport auger 82.

Mylar Portion 70

The Mylar portion 70 is an example of a loosening member and is disposed in the storage housing 40 so as to be pulled out as FIG. 2 and FIG. 5 illustrate. Specifically, as FIG. 5 illustrates, the Mylar portion 70 is disposed so as to pass near the inner surfaces of a front wall 40A, a ceiling 40C, and a back wall 40B of the storage housing 40. That is, before being pulled out of the storage housing 40, the Mylar portion 70 is constituted by: a drawable portion 71 passing through the pull-out hole portion 46 provided in the front wall 40A; a front-side vertical portion 72 extending upward from the drawable portion 71 along the front wall 40A of the storage housing 40; a horizontal portion 73 extending backward from the front-side vertical portion 72 along the ceiling 40C; and a back-side vertical portion 74 extending downward from the horizontal portion 73 along the back wall 40B of the storage housing 40.

With an operation of pulling out of the inner space of the storage housing 40, the Mylar portion 70 loosens the developer G stored in the storage housing 40. Specifically, as FIG. 8 illustrates, with the pull-out operation, the Mylar portion 70 has a function of: pushing out the developer G toward the accommodation portion 63 (specifically, toward the stirring path 62) through the opening portion 42 from which the sealing member 50 is removed; and simultaneously loosening the developer G that has become hard in the storage housing 40.

As FIG. 5 and FIG. 6 illustrate, the Mylar portion 70 includes the drawable portion 71 (including a front end 70A of the Mylar portion 70) sticking out of the storage housing 40 through the pull-out hole portion 46. On the other hand, a back end 70B (included in the back-side vertical portion 74) of the Mylar portion 70 is attached to the inner surface of the back wall 40B of the storage housing 40. Specifically, the back end 70B of the Mylar portion 70 is removably bonded to the inner surface of the back wall 40B with a double-sided tape piece 78 (refer to FIG. 5). Here, after pulling out the sealing member 50, a user catches hold of the drawable portion 71, of the Mylar portion 70, sticking out of the pull-out hole portion 46 of the storage housing 40 and pulls out the Mylar portion 70 frontward, and the developer G in the storage housing 40 is thereby loosened (refer to FIG. 8). The user pulls the Mylar portion 70 further frontward, and the back end 70B of the Mylar portion 70 thereby becomes detached from the inner surface of the back wall 40B of the storage housing 40 (refer to FIG. 10). Accordingly, the Mylar portion 70 has been pulled out of the storage housing 40. Note that, although the back end 70B of the Mylar portion 70 is removably bonded to the inner surface of the back wall 40B with the double-sided tape piece 78 in the present exemplary embodiment, the present disclosure is not limited thereto, and the back end 70B of the Mylar portion 70 may be attached to the inner surface of the back wall 40B by a method other than the method using double-sided tape.

The Mylar portion 70 has a film shape. Examples of the material of the Mylar portion 70 include a resin film. Examples of the resin used for the Mylar portion 70 may include polyethylene terephthalate (PET).

Sealing Clip 90

As FIG. 5 and FIG. 6 illustrate, the sealing clip 90 is disposed in the pull-out hole portion 46, of the storage housing 40, for the Mylar portion 70. Specifically, the sealing clip 90 is inserted into the pull-out hole portion 46 from the front side relative to the storage housing 40 to be disposed in the pull-out hole portion 46.

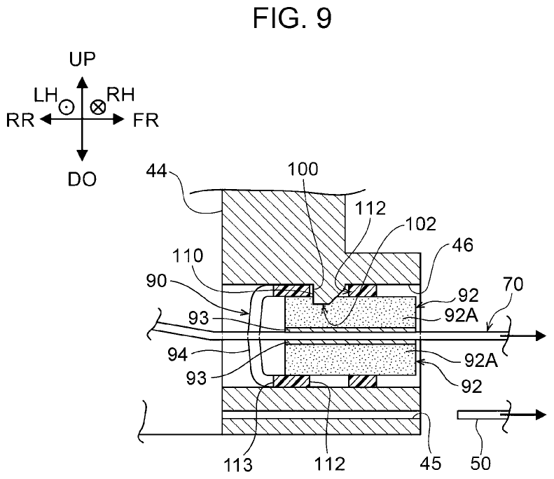

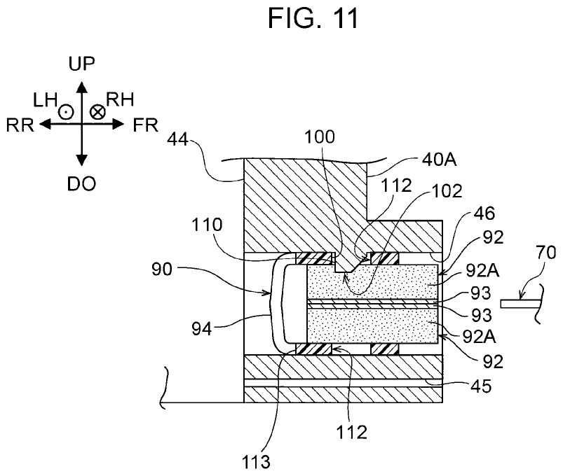

The sealing clip 90 is in contact with and cleans the Mylar portion 70 that is pulled out through the pull-out hole portion 46. Specifically, the sealing clip 90 has a function of cleaning both sides (top side and reverse side) of the Mylar portion 70 when the Mylar portion 70 is pulled from the inner space of the storage housing 40 (refer to FIG. 9). The sealing clip 90 further has a function of closing the pull-out hole portion 46 after the Mylar portion 70 has been pulled out of the pull-out hole portion 46 (refer to FIG. 11).

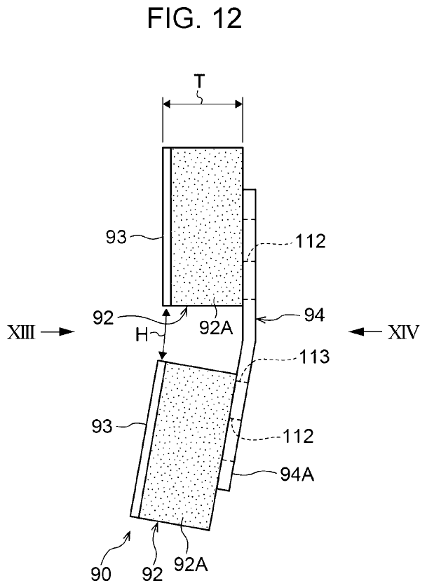

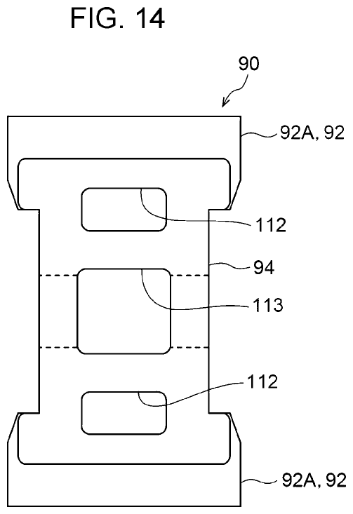

As FIGS. 12 to 14 illustrate, the sealing clip 90 includes a pair of low-elastic portions 92 and a high-elastic portion 94.

Each of the low-elastic portions 92 is a member having low elasticity. Such a member having low elasticity may be, for example, a cushion member made of urethane. As FIG. 6 illustrates, a pair of the low-elastic portions 92 are disposed so as to face one another with the sealing clip 90 being inserted in the pull-out hole portion 46. The low-elastic portions 92 hold the Mylar portion 70 from opposite sides. Specifically, a pair of the low-elastic portions 92 hold both sides (top side and reverse side) of the Mylar portion 70 from opposite sides. Note that, in the present exemplary embodiment, the low-elastic portions 92 are provided on both longitudinal end portions of the single high-elastic portion 94 (refer to FIGS. 12 to 14).

The high-elastic portion 94 has elasticity (to compression) higher than that of the low-elastic portions 92 and is a plate-shaped member. The high-elastic portion 94 may be, for example, a plate-shaped member of polyethylene terephthalate (PET). Note that examples of such a plate shape here include a film shape. That is, examples of the plate-shaped high-elastic portion 94 include a film-shaped member and a member thicker than a film. As FIG. 6 illustrates, with the sealing clip 90 being inserted in the pull-out hole portion 46, the high-elastic portion 94 is fixed to a surface, of each of the low-elastic portions 92, on the opposite side from the Mylar portion 70 side, and a plate surface 94A, of the high-elastic portion 94, on the opposite side from the low-elastic portion 92 side is in contact with an inner surface of the pull-out hole portion 46.

A surface layer of each of the low-elastic portions 92 is constituted by a fiber material portion 93. The fiber material portion 93 is a portion for cleaning the Mylar portion 70. That is, the low-elastic portion 92 includes a cushion portion 92A and the fiber material portion 93. A material such as a woven or nonwoven fabric may be used for the fiber material portion 93. Although felt is used for the fiber material portion 93 in the present exemplary embodiment, there is no particular limit on the material, and any member capable of easily cleaning the developer G sticking to the Mylar portion 70 may be used. In addition, the fiber material portion 93 may be omitted, and the cushion portion 92A may directly clean the Mylar portion 70.

Here, the sealing clip 90 is inserted into the pull-out hole portion 46, with the high-elastic portion 94 being bent so that the low-elastic portions 92, which are provided on both longitudinal side portions of the high-elastic portion 94, are in contact with one another. When the sealing clip 90 is inserted into the pull-out hole portion 46 until reaching a predetermined position, a protruding portion 102 is inserted into an opening portion 112. At this time, the high-elastic portion 94 that has been pressed by the protruding portion 102 is elastically returned, and it is thereby possible for an assembly operator to know that the sealing clip 90 has been inserted and positioned at the predetermined position.

Caught Portion 100

As FIG. 6 illustrates, the caught portion 100 is provided in the sealing clip 90. Specifically, the caught portion 100 is provided in the high-elastic portion 94. More specifically, the high-elastic portion 94 has the opening portion 112 into which the protruding portion 102, which will be described later, is insertable. The caught portion 100 is an upstream edge portion of the opening portion 112 in a direction where the Mylar portion 70 is pulled out (hereinafter, referred to simply as a “pull-out direction”). Note that, although the opening portion 112 may be a recessed portion or a through hole portion formed in the high-elastic portion 94, the opening portion 112 of the present exemplary embodiment is a through hole portion passing through the high-elastic portion 94 in the thickness direction of the high-elastic portion 94.

In addition, as FIG. 6 illustrates, with the sealing clip 90 being inserted in the pull-out hole portion 46, the opening portion 112 is formed in each of the portions, of the high-elastic portion 94, arranged opposite to one another with the facing low-elastic portions 92 interposed therebetween. In other words, in the high-elastic portion 94, a portion on one side in the longitudinal direction has the opening portion 112 in a region where the portion of the high-elastic portion 94 on the one side and one of the low-elastic portions 92 overlap one another, and a portion on the other side in the longitudinal direction has the opening portion 112 in a region where the portion of the high-elastic portion 94 on the other side and the other of the low-elastic portions 92 overlap one another.

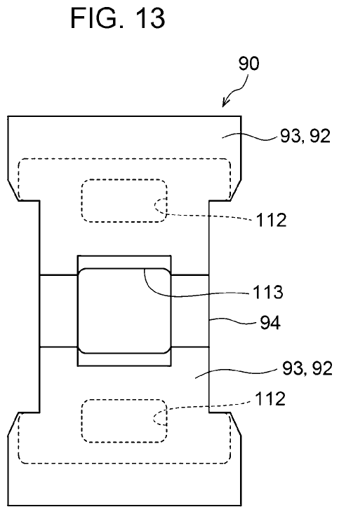

Each of the opening portions 112 of the high-elastic portion 94 has a substantially rectangular shape as FIG. 13 illustrates. In addition, an opening 113 is formed in a central portion, in the longitudinal direction, of the high-elastic portion 94, that is, in a region between a pair of the opening portions 112 in the longitudinal direction. The opening 113 is a through hole through which the Mylar portion 70 passes, with the high-elastic portion 94 being bent, that is, with the sealing clip 90 being inserted in the pull-out hole portion 46. The opening 113 has a substantially rectangular shape as FIG. 13 illustrates. Although the opening 113 is larger than the opening of the opening portion 112 in the present exemplary embodiment, the size of the opening 113 is not limited thereto.

Limiting Portion 110

As FIG. 6 illustrates, the limiting portion 110 is provided in the pull-out hole portion 46. The movement of the sealing clip 90 in the pull-out direction with the pull-out operation of the Mylar portion 70 is limited by the limiting portion 110 catching the caught portion 100. Specifically, as FIG. 6 illustrates, the pull-out hole portion 46 has the protruding portion 102 protruding from the inner surface of the pull-out hole portion 46. The limiting portion 110 is an upstream portion of the protruding portion 102 in the pull-out direction. Note that, in the present exemplary embodiment, the limiting portion 110 is an upstream wall portion of the protruding portion 102 in the pull-out direction, and the wall portion extends in a direction orthogonal to the pull-out direction when viewed in FIG. 6.

Although, in the present exemplary embodiment, one protruding portion 102 is provided on the inner surface of the pull-out hole portion 46, that is, specifically, on the upper inner surface, the present disclosure is not limited thereto. For example, protruding portions 102 may be provided on the respective upper and lower inner surfaces of the pull-out hole portion 46. In this case, the protruding portions 102 are inserted in the respective paired opening portions 112 of the sealing clip 90.

As FIG. 6 illustrates, with the sealing clip 90 being put in the pull-out hole portion 46, the protruding portion 102 inserted in the opening portion 112 presses the low-elastic portion 92 against the Mylar portion 70.

When the pull-out hole portion 46 is viewed in a section orthogonal to the pull-out direction (viewed in FIG. 7), the Mylar portion 70 is positioned in a protruding direction of the protruding portion 102.

In the protruding portion 102 viewed in the protruding direction, a length L1 in a direction orthogonal to the pull-out direction is greater than a length L2 in the pull-out direction. Specifically, in the protruding portion 102, the length L1 in the direction orthogonal to the pull-out direction when viewed in FIG. 7 is greater than the length L2 in the pull-out direction when viewed in FIG. 6.

As FIG. 12 illustrates, in the sealing clip 90 in a no-load state, a value of a distance H between a pair of the low-elastic portions 92 is smaller than a value of a thickness T of each of the low-elastic portions 92.

Operation of Supplying Accommodation Portion 63 with Developer G Stored in Storage Housing 40

As FIG. 5 illustrates, first, a user catches hold of the front end of the sealing member 50 sticking out of the pull-out hole 45 and pulls the front end of the sealing member 50 frontward. Accordingly, as FIG. 6 illustrates, the opening portion 42 is opened, and the developer G stored in the storage housing 40 starts to fall down to the stirring path 62 through the opening portion 42.

Next, when the user catches hold of the drawable portion 71, of the Mylar portion 70, sticking out of the pull-out hole portion 46 and pulls the drawable portion 71 frontward, the Mylar portion 70, as FIG. 8 illustrates, moves toward the opening portion 42 (that is, downward), and the developer G stored in the storage housing 40 is loosened and pushed out to the stirring path 62 through the opening portion 42. That is, the Mylar portion 70 pushes out the developer G that is left in the storage housing 40 after the sealing member 50 has been pulled out, into the stirring path 62 through the opening portion 42 while loosening the developer G.

When being further pulled, the Mylar portion 70 is pulled out of the storage housing 40 (refer to FIG. 10 and FIG. 11). When the Mylar portion 70 has been pulled out, the facing fiber material portions 93 of the sealing clip 90 come into contact with one another to close the pull-out hole portion 46.

In the above-described way, the developer G stored in the storage housing 40 is supplied to the accommodation portion 63 (specifically, to the stirring path 62). The developer devices 38 each including the accommodation portion 63 (specifically, the stirring path 62) that has been supplied with the developer G are then mounted in the respective toner image forming units 20Y to 20K.

### Functions of Present Exemplary Embodiment

In the developing device 38 of the present exemplary embodiment, when the Mylar portion 70 is pulled out through the pull-out hole portion 46 of the storage housing 40, the caught portion 100 of the sealing clip 90 is caught by the limiting portion 110 of the pull-out hole portion 46. Thus, against the pull-out force acting on the sealing clip 90 when the Mylar portion 70 is pulled out, the movement of the sealing clip 90 in the pull-out direction of the Mylar portion 70 is limited by the caught portion 100 being caught by the limiting portion 110. Thus, with the developing device 38, when the Mylar portion 70 is pulled out, the sealing clip 90 may be suppressed from coming out of the pull-out hole portion 46 through which the Mylar portion 70 is pulled from the inner space of the storage housing 40 that stores the developer G, compared with a configuration where the sealing clip 90 is disposed in the pull-out hole portion 46 so as to move in the pull-out direction.

The developing device 38 in the present exemplary embodiment further has the protruding portion 102 protruding from the inner surface of the pull-out hole portion 46. The limiting portion 110 is an upstream portion of the protruding portion 102 in the pull-out direction. Thus, with the developing device 38, the sealing clip 90 may easily close the pull-out hole portion 46, compared with a configuration where, in a hole portion having a small-diameter portion, the limiting portion 110 is an upstream portion of the small-diameter portion in the pull-out direction of the Mylar portion 70.

The developing device 38 of the present exemplary embodiment includes the sealing clip 90 including the low-elastic portions 92 and the high-elastic portion 94. In addition, the high-elastic portion 94 has the opening portion 112 into which the protruding portion 102 is insertable. The caught portion 100 is an upstream edge portion of the opening portion 112 in the pull-out direction. Thus, with the developing device 38, the sealing clip 90 may be easily disposed in the pull-out hole portion 46, compared with a configuration where the low-elastic portions 92 are in contact with the inner surface of the pull-out hole portion 46.

In the developing device 38 of the present exemplary embodiment, the low-elastic portion 92 is pressed against the Mylar portion 70 by the protruding portion 102 inserted in the opening portion 112, which is a through hole portion. Thus, the cleanability of the Mylar portion 70 with the sealing clip 90 may be improved, compared with a configuration where the protruding portion 102 inserted in the opening portion 112 is not in contact with the low-elastic portion 92.

In the developing device 38 of the present exemplary embodiment, the Mylar portion 70 is positioned in the protruding direction of the protruding portion 102 when the pull-out hole portion 46 is viewed in a section orthogonal to the pull-out direction. Thus, the cleanability of the Mylar portion 70 with the sealing clip 90 may be improved, compared with a configuration where the Mylar portion 70 is not positioned in the protruding direction of the protruding portion 102 when the pull-out hole portion 46 is viewed in a section orthogonal to the pull-out direction of the Mylar portion 70.

In the developing device 38 of the present exemplary embodiment, when the protruding portion 102 is viewed in the protruding direction, the length L1 in a direction orthogonal to the pull-out direction is greater than the length L2 in the pull-out direction. Thus, the Mylar portion 70 may be easily pulled out, and the cleanability of the Mylar portion 70 with the sealing clip 90 may be improved, compared with a configuration where the length L1 in a direction orthogonal to the pull-out direction is smaller than or equal to the length L2 in the pull-out direction when the protruding portion is viewed in the protruding direction.

In the developing device 38 of the present exemplary embodiment, the opening portions 112 are formed in the respective portions, of the high-elastic portion 94, arranged opposite to one another with the facing low-elastic portions 92 interposed therebetween. Thus, the protruding portion 102 may be insertable into one of the opening portions 112 even when the sealing clip 90 is turned upside down, compared with a configuration where the opening portions 112 is provided in only one of the portions, of the high-elastic portion 94, arranged opposite to one another with the facing low-elastic portions 92 interposed therebetween.

The developing device 38 of the present exemplary embodiment includes the pull-out hole portion 46 whose inner surface has one protruding portion 102. Thus, the storage housing 40 may be easily produced compared with a configuration where plural protruding portions 102 are provided on the inner surface of the pull-out hole portion 46.

The image forming apparatus 10 of the present exemplary embodiment includes the photoconductor 32 that holds a latent image and the developing device 38 that develops the latent image. Thus, compared with a configuration where the sealing clip 90 is disposed in the pull-out hole portion 46 through which the Mylar portion 70 is pulled from the inner space of the storage housing 40 that stores the developer G, and the sealing clip 90 is movable in the pull-out direction, the contamination of the apparatus caused by the sealing clip 90 coming out may be suppressed.

Modifications

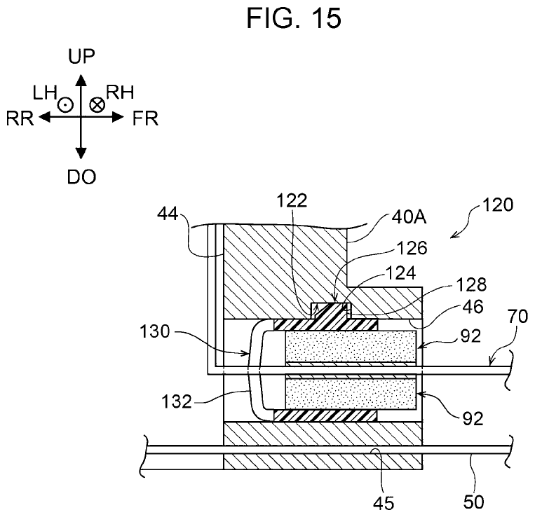

Although, in the developing device 38 of the above-described exemplary embodiment, the pull-out hole portion 46 includes the limiting portion 110, and the sealing clip 90 includes the caught portion 100, the present disclosure is not limited thereto. As with a developing device 120 illustrated in FIG. 15, the inner surface of the pull-out hole portion 46 may have a recessed portion 122, and a downstream wall portion of the recessed portion 122 in the pull-out direction may constitute a limiting portion 124. Specifically, as in FIG. 15, a sealing clip 130 may include a high-elastic portion 132 having a protruding portion 126 that is insertable into the recessed portion 122, and a downstream portion of the protruding portion 126 in the pull-out direction of the Mylar portion 70 may serve as a caught portion 128. In this case, the functions and effects similar to those of the developing device 38 of the above-described exemplary embodiment may also be exhibited. Specifically, with the developing device 120, the sealing clip 90 may easily close the pull-out hole portion 46, compared with a configuration where, in the pull-out hole portion 46 having a small-diameter portion, an upstream portion of the small-diameter portion in the pull-out direction of the Mylar portion 70 serves as a limiting portion. In addition, with the developing device 120, the sealing clip 90 may be easily disposed in the pull-out hole portion 46, compared with a configuration where the low-elastic portions 92 are in contact with the inner surface of the pull-out hole portion 46.

Although, in the developing device 38 of the above-described exemplary embodiment, the Mylar portion 70 is pulled out after the sealing member 50 has been pulled out, the present disclosure is not limited thereto. For example, the Mylar portion 70 may be pulled out in conjunction with the pull-out operation of the sealing member 50. Moreover, the developing device 38 may include another sealing member that closes the inflow port 48. The Mylar portion 70 may be pulled out in conjunction with the pull-out operation of this sealing member.

Although the pull-out hole portion 46 includes the protruding portion 102, and the sealing clip 90 has the opening portion 112 in the developing device 38 of the above-described exemplary embodiment, the present disclosure is not limited thereto. For example, the pull-out hole portion 46 may include the protruding portion 102, and an outer surface of the high-elastic portion 94 of the sealing clip 90 may have a protrusion (examples thereof include a rib) that is caught by the protruding portion 102. In addition, although the upstream wall portion of the protruding portion 102 in the pull-out direction serves as the limiting portion 110 in the developing device 38 of the above-described exemplary embodiment, the present disclosure is not limited thereto. For example, the pull-out hole portion 46 may have a small diameter on the inflow side and a large diameter on the deeper side, and a step formed between the small-diameter side and the large-diameter side may serve as a limiting portion.

Although the low-elastic portions 92 are fixed to both the respective longitudinal end portions of the high-elastic portion 94 in the developing device 38 of the above-described exemplary embodiment, the present disclosure is not limited thereto. For example, one low-elastic portion 92 may be fixed to the high-elastic portion 94 along a plate surface of the high-elastic portion 94. In this case, the number of low-elastic portions 92 is reduced, and the component management may be simplified.

Although the protruding portion 102 passes through the opening portion 112 and presses the low-elastic portion 92 against the Mylar portion 70 in the developing device 38 of the above-described exemplary embodiment, the present disclosure is not limited thereto. The protruding portion 102 may be required to be at the very least caught in the opening portion 112 when the sealing clip 90 is moved in the pull-out direction. Thus, the protruding portion 102 does not necessarily press the low-elastic portion 92. That is, the top of the protruding portion 102 is not necessarily in contact with the low-elastic portion 92. In other words, the height of the protruding portion 102 may be smaller than the depth of the opening portion 112. Moreover, the sealing clip 90 may be easily positioned with a configuration where the protruding portion 102 is caught in the opening portion 112 when the sealing clip 90 is moved in a direction opposite to the pull-out direction.

The present disclosure is not limited to the above-described exemplary embodiment, and various modifications, changes, and improvements may be made without departing from the spirit of the present disclosure. For example, ones of the above-described modifications may be appropriately combined.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A developing device comprising:
a storage portion that stores a developer and has an exit for the developer and a hole portion, the hole portion including a limiting portion;
a sealing member with which the exit of the storage portion is sealed;
a loosening member that is disposed in the storage portion so as to be pulled out through the hole portion of the storage portion and loosens the developer by being pulled out of the storage portion; and
a closing member that is disposed in the hole portion of the storage portion, cleans the loosening member that is pulled out of the hole portion by being in contact with the loosening member, and closes the hole portion of which the loosening member has been pulled out, the closing member including a caught portion, wherein:
the limiting portion of the hole portion of the storage portion limits a movement of the closing member in a pull-out direction of the loosening member by catching the caught portion.

(((2)))

The developing device according to (((1))), wherein:
the limiting portion is a protruding portion provided on an inner surface of the hole portion.

(((3)))

The developing device according to (((2))), wherein:
the closing member includes: a low-elastic portion having portions that face one another and hold the loosening member from opposite sides; and a high-elastic portion that has a plate shape and elasticity higher than elasticity of the low-elastic portion and is fixed to a surface, of the low-elastic portion, opposite from a surface, of the low-elastic portion, facing the loosening member and whose plate surface opposite from a plate surface facing the low-elastic portion is in contact with the inner surface of the hole portion;
the high-elastic portion includes at least one opening portion into which the protruding portion is insertable; and
the caught portion is the at least one opening portion.

(((4)))

The developing device according to (((3))), wherein:
the at least one opening portion is a through hole portion passing through the high-elastic portion; and
the protruding portion that is inserted into the through hole portion presses the low-elastic portion against the loosening member.

(((5)))

The developing device according to (((4))), wherein:
when the hole portion is viewed in a section orthogonal to the pull-out direction, the loosening member is positioned in a protruding direction of the protruding portion.

(((6)))

The developing device according to (((5))), wherein:
when the protruding portion is viewed in the protruding direction, in the protruding portion, a length in a direction orthogonal to the pull-out direction is greater than a length in the pull-out direction.

(((7)))

The developing device according to any one of (((3))) to (((6))), wherein:
the at least one opening portion comprises a plurality of opening portions, and the plurality of opening portions are provided in parts, of the high-elastic portion, arranged opposite to one another with the low-elastic portion having the portions facing one another interposed between the parts of the high-elastic portion.

(((8)))

The developing device according to (((7))), wherein:
the inner surface of the hole portion has the single protruding portion.

(((9)))

The developing device according to (((1))), wherein:
the limiting portion is a recessed portion provided in an inner surface of the hole portion.

(((10)))

The developing device according to (((9))), wherein:
the closing member includes: a low-elastic portion having portions that face one another and hold the loosening member from opposite sides; and a high-elastic portion that has a plate shape and elasticity higher than elasticity of the low-elastic portion and is fixed to a surface, of the low-elastic portion, opposite from a surface, of the low-elastic portion, facing the loosening member and whose plate surface opposite from a plate surface facing the low-elastic portion is in contact with the inner surface of the hole portion;
the high-elastic portion includes a protruding portion being insertable into the recessed portion; and
the caught portion is the protruding portion.

(((11)))

An image forming apparatus comprising:
a holding body that holds a latent image; and
the developing device, according to any one of (((1))) to (((10))), that develops the latent image.

What is claimed is:

1. A developing device comprising:
a storage portion that stores a developer and has an exit for the developer and a hole portion, the hole portion including a limiting portion;
a sealing member with which the exit of the storage portion is sealed;
a loosening member that is disposed in the storage portion so as to be pulled out through the hole portion of the storage portion and loosens the developer by being pulled out of the storage portion; and
a closing member that is disposed in the hole portion of the storage portion, cleans the loosening member that is pulled out of the hole portion by being in contact with the loosening member, and closes the hole portion of which the loosening member has been pulled out, the closing member including a caught portion, wherein:
the limiting portion of the hole portion of the storage portion limits a movement of the closing member in a pull-out direction of the loosening member by catching the caught portion.

2. The developing device according to claim 1, wherein:
the limiting portion is a protruding portion provided on an inner surface of the hole portion.

3. The developing device according to claim 2, wherein:
the closing member includes: a low-elastic portion having portions that face one another and hold the loosening member from opposite sides; and a high-elastic portion that has a plate shape and elasticity higher than elasticity of the low-elastic portion and is fixed to a surface, of the low-elastic portion, opposite from a surface, of the low-elastic portion, facing the loosening member and whose plate surface opposite from a plate surface facing the low-elastic portion is in contact with the inner surface of the hole portion;
the high-elastic portion includes at least one opening portion into which the protruding portion is insertable; and
the caught portion is the at least one opening portion.

4. The developing device according to claim 3, wherein:
the at least one opening portion is a through hole portion passing through the high-elastic portion; and
the protruding portion that is inserted into the through hole portion presses the low-elastic portion against the loosening member.

5. The developing device according to claim 4, wherein:
when the hole portion is viewed in a section orthogonal to the pull-out direction, the loosening member is positioned in a protruding direction of the protruding portion.

6. The developing device according to claim 5, wherein:
when the protruding portion is viewed in the protruding direction, in the protruding portion, a length in a direction orthogonal to the pull-out direction is greater than a length in the pull-out direction.

7. The developing device according to claim 3, wherein:
the at least one opening portion comprises a plurality of opening portions, and the plurality of opening portions are provided in parts, of the high-elastic portion, arranged opposite to one another with the low-elastic portion having the portions facing one another interposed between the parts of the high-elastic portion.

8. The developing device according to claim 7, wherein:
the inner surface of the hole portion has the single protruding portion.

9. The developing device according to claim 1, wherein:
the limiting portion is a recessed portion provided in an inner surface of the hole portion.

10. The developing device according to claim 9, wherein:
the closing member includes: a low-elastic portion having portions that face one another and hold the loosening member from opposite sides; and a high-elastic portion that has a plate shape and elasticity higher than elasticity of the low-elastic portion and is fixed to a surface, of the low-elastic portion, opposite from a surface, of the low-elastic portion, facing the loosening member and whose plate surface opposite from a plate surface facing the low-elastic portion is in contact with the inner surface of the hole portion;
the high-elastic portion includes a protruding portion being insertable into the recessed portion; and
the caught portion is the protruding portion.

11. An image forming apparatus comprising:
a holding body that holds a latent image; and
the developing device, according to claim 1, that develops the latent image.

12. An image forming apparatus comprising:
a holding body that holds a latent image; and
the developing device, according to claim 2, that develops the latent image.

13. An image forming apparatus comprising:
a holding body that holds a latent image; and
the developing device, according to claim 3, that develops the latent image.

14. An image forming apparatus comprising:
a holding body that holds a latent image; and
the developing device, according to claim 4, that develops the latent image.

15. An image forming apparatus comprising:
a holding body that holds a latent image; and
the developing device, according to claim 5, that develops the latent image.

16. An image forming apparatus comprising:
a holding body that holds a latent image; and
the developing device, according to claim 6, that develops the latent image.

17. An image forming apparatus comprising:
a holding body that holds a latent image; and
the developing device, according to claim 7, that develops the latent image.

18. An image forming apparatus comprising:
a holding body that holds a latent image; and
the developing device, according to claim 8, that develops the latent image.

19. An image forming apparatus comprising:
a holding body that holds a latent image; and
the developing device, according to claim 9, that develops the latent image.

20. An image forming apparatus comprising:
a holding body that holds a latent image; and
the developing device, according to claim 10, that develops the latent image.
